(19) United States
(12) Patent Application Publication
(10) Pub. No.: US 2021/0357589 A1
(43) Pub. Date: Nov. 18, 2021

(54) METHOD OF DETECTING CHANGE AND INFORMATION PROCESSING APPARATUS

(71) Applicant: FUJITSU LIMITED, Kawasaki-shi (JP)

(72) Inventor: Kensuke Baba, Fukuoka (JP)

(73) Assignee: FUJITSU LIMITED, Kawasaki-shi (JP)

(21) Appl. No.: 17/209,249

(22) Filed: Mar. 23, 2021

(30) Foreign Application Priority Data
May 14, 2020 (JP) 2020-085172

(51) Int. Cl. G06F 40/289; G06F 16/33

(52) U.S. Cl. CPC G06F 40/289; G06N 20/00; G06F 16/3347

(57) ABSTRACT

A non-transitory computer-readable recording medium has stored therein a program that causes a computer to execute a process, the process including calculating, based on words included in each of a plurality of sentences included in a target document, a plurality of vectors that respectively correspond to the plurality of sentences, executing a frequency analysis based on the plurality of vectors and a time axis associated with the plurality of vectors according to a writing order of the plurality of sentences in the target document, and outputting information that indicates a position that corresponds to a change point identified based on a result of the frequency analysis, in the target document.

### CROSS-REFERENCE TO RELATED APPLICATION

This application is based upon and claims the benefit of priority of the prior Japanese Patent Application No. 2020-085172, filed on May 14, 2020, the entire contents of which are incorporated herein by reference.

### FIELD

The embodiment discussed herein is related to a change detecting technique.

### BACKGROUND

In recent years, for example, in order to identify a topic included in document data such as minutes of a meeting or the like (hereinafter, also referred to as target document data), an information processing system for detecting sentences related to the same topic has been constructed.

Specifically, the information processing system calculates a similarity of contents of each sentence included in the target document data by using, for example, statistical information about the appearance frequency of each word in other document data (hereinafter, also referred to as training document data). Then, by using the calculated similarity, the information processing system distributes the sentences included in the target document data to multiple clusters, such that multiple sentences which may be determined to have similar contents are distributed to the same cluster. Further, the information processing system outputs, for example, a determination result that one or more sentences distributed to the same cluster are related to the same topic.

Related technologies are disclosed in, for example, Japanese Laid-Open Patent Publication No. 2015-225134, Japanese Laid-Open Patent Publication No. 2007-241902, and Japanese Laid-Open Patent Publication No. 2004-185135.

### SUMMARY

According to an aspect of the embodiment, a non-transitory computer-readable recording medium has stored therein a program that causes a computer to execute a process, the process including: calculating, based on words included in each of a plurality of sentences included in a target document, a plurality of vectors that respectively correspond to the plurality of sentences; executing a frequency analysis based on the plurality of vectors and a time axis associated with the plurality of vectors according to a writing order of the plurality of sentences in the target document; and outputting information that indicates a position that corresponds to a change point identified based on a result of the frequency analysis, in the target document.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing system;

FIG. 2 is a view illustrating a specific example of a process in a change detecting device;

FIGS. 3A and 3B are views illustrating a specific example of the process in the change detecting device;

FIGS. 4A to 4I are views illustrating a specific example of the process in the change detecting device;

FIG. 5 is a view illustrating a hardware configuration of the change detecting device;

FIG. 6 is a functional block diagram of the change detecting device;

FIG. 7 is a flowchart illustrating an outline of a change detecting process according to a first embodiment;

FIG. 8 is a view illustrating details of the change detecting process according to the first embodiment;

FIG. 9 is a flowchart illustrating details of the change detecting process according to the first embodiment;

FIG. 10 is a flowchart illustrating details of the change detecting process according to the first embodiment;

FIG. 11 is a flowchart illustrating details of the change detecting process according to the first embodiment;

FIG. 12 is a view illustrating a specific example of document data;

FIG. 13 is a view illustrating a specific example of statistical information;

FIG. 14 is a view illustrating details of the change detecting process according to the first embodiment;

FIGS. 15A and 15B are views illustrating details of the change detecting process according to the first embodiment;

FIGS. 16A and 16B are views illustrating details of the change detecting process according to the first embodiment;

FIGS. 17A and 17B are views illustrating details of the change detecting process according to the first embodiment; and

FIG. 18 is a view illustrating details of the change detecting process according to the first embodiment.

### DESCRIPTION OF EMBODIMENT

When distributing the sentences included in the target document data to multiple clusters, the information processing system makes a determination in consideration of a relationship of each sentence with its previous and subsequent sentences (hereinafter, also simply referred to as the context).

However, the range of sentences of which context needs to be considered varies according to the presence/absence of noise included in the target document data (sentences unrelated to a topic that corresponds to each cluster). Thus, when distributing the sentences included in the target document data to multiple clusters, the information processing system needs to make a determination while changing the range of sentences of which context needs to be considered. As a result, the information processing system may require a relatively long time for detecting sentences related to the same topic in the target document data.

<Configuration of Information Processing System>

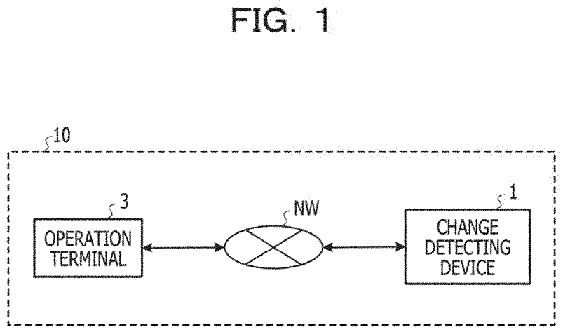

First, a configuration of an information processing system 10 will be described. FIG. 1 is a diagram illustrating the configuration of the information processing system 10. The information processing system 10 illustrated in FIG. 1 includes a change detecting device 1 (hereinafter, also referred to as an information processing device 1) and an operation terminal 3.

The operation terminal 3 is a terminal with which, for example, an operation inputs necessary information or the like, and may be a PC (personal computer). Further, the operation terminal 3 is a terminal capable of communicating with the change detecting device 1 via a network NW.

The change detecting device 1 is configured by, for example, one or more physical or virtual machines, and performs a process of detecting a change point of a topic in target document data (hereinafter, also referred to as a change detecting process).

Specifically, for example, by using statistical information about the appearance frequency of each word in training document data, the change detecting device 1 calculates vector values that correspond to the sentences included in the target document data, respectively. Then, by using a similarity of the calculated vector values, the change detecting device 1 distributes the sentences included in the target document data to multiple clusters, such that multiple sentences which may be determined to have similar contents are distributed to the same cluster. Then, the change detecting device 1 outputs, for example, a determination result that one or more sentences distributed to the same cluster are related to the same topic, to the operation terminal 3. Hereinafter, a specific example of the process performed in the change detecting device 1 will be described.

<Specific Example of Process Performed in Change Detecting Device>

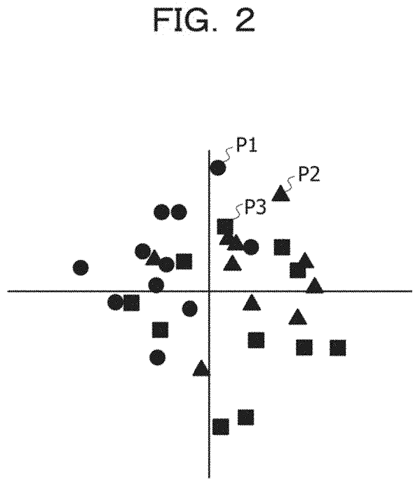

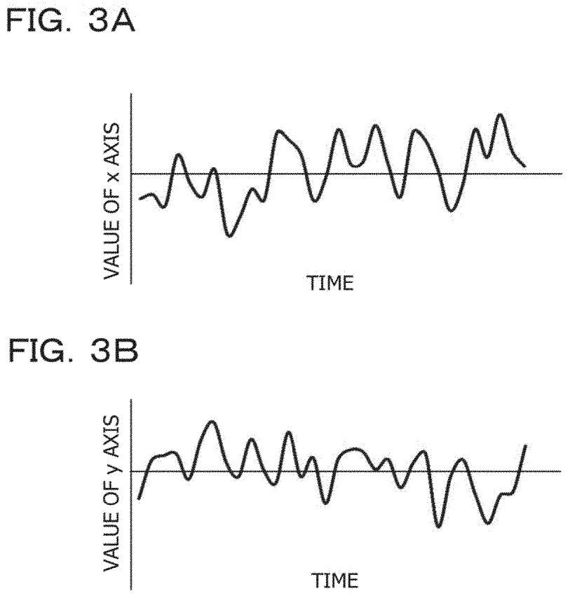

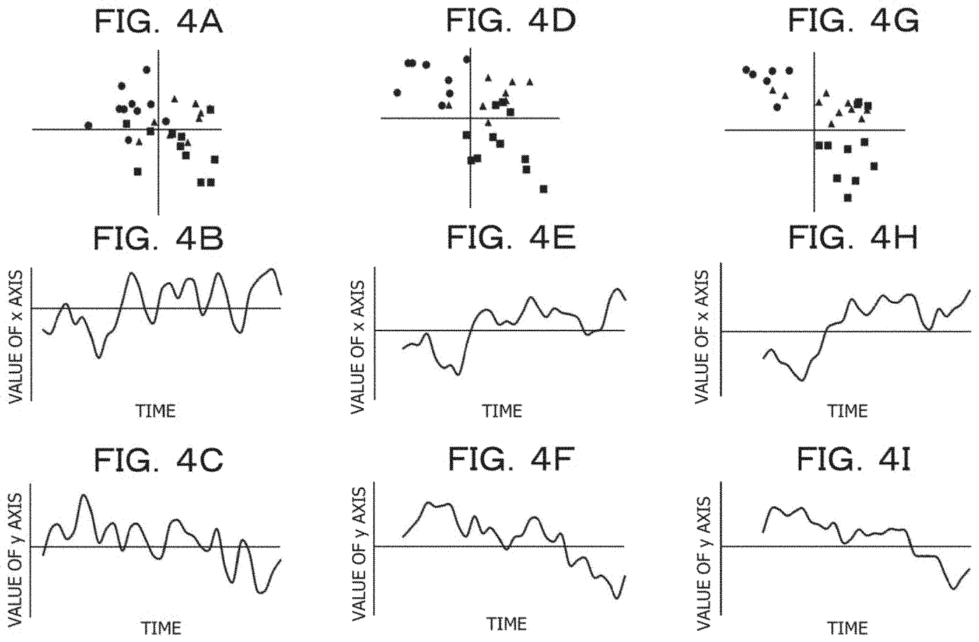

FIG. 2 through FIGS. 4A to 4I are views illustrating a specific example of the process performed in the change detecting device 1. FIG. 2 is a specific example illustrating vector values of the respective sentences included in the target document data. Further, FIGS. 3A and 3B are specific examples illustrating time-series data of the vector values of the respective sentences which are expressed according to a writing order in the target document data. Further, FIGS. 4A to 4I are specific examples in a case where a moving average is performed on the vector values of the respective sentences included in the target document data. Meanwhile, hereinafter, descriptions will be made assuming that a vector value of each sentence is two-dimensional vector values.

Specifically, as illustrated in FIG. 2, for each sentence included in the target document data, the change detecting device 1 plots a point where two-dimensional vector values that correspond to each sentence are associated with a value on the horizontal axis (X axis) and a value on the vertical axis (Y axis), respectively, on a two-dimensional plane. In the example illustrated in FIG. 2, a point P1 that corresponds to a circle is, for example, a point of a vector value that corresponds to a sentence written at the beginning of the target document data. Further, in the example illustrated in FIG. 2, a point P2 that corresponds to a triangle is, for example, a point of a vector value that corresponds to a sentence written in the middle of the target document data. Further, in the example illustrated in FIG. 2, a point P3 that corresponds to a square is, for example, a point of a vector value that corresponds to a sentence written at the end of the target document data.

Then, the change detecting device 1 distributes each of the multiple vector values that correspond to the respective sentences included in the target document data, to multiple clusters based on the inter-vector distance in the graph represented in FIG. 2.

Specifically, for example, the change detecting device 1 distributes each of the multiple vector values that correspond to the respective sentences included in the target document data, to multiple clusters, such that vectors relatively close to each other on the plane represented in FIG. 2 are distributed to the same cluster.

Here, when the respective sentences included in the target document data are distributed to clusters by using the vector values of the sentences as described above, the change detecting device 1 may not accurately distribute the sentences to the clusters.

Accordingly, for example, as illustrated in FIG. 3A, the change detecting device 1 generates time-series data for a first vector value of the two-dimensional vector values that correspond to each sentence (a vector value that corresponds to a value on the X axis in FIG. 2). Further, for example, as illustrated in FIG. 3B, the change detecting device 1 generates time-series data for a second vector value of the two-dimensional vector values that correspond to each sentence (a vector value that corresponds to a value on the Y axis in FIG. 2).

Then, the change detecting device 1 distributes the respective sentences included in the target document data to clusters, based on the changing state of values in each of the time-series data generated in FIGS. 3A and 3B.

Here, in order to distribute the sentences to clusters as described above, time-series data that exhibits a rough change may be used. Thus, when distributing the respective sentences included in the target document data to multiple clusters, the change detecting device 1 makes a determination in consideration of a relationship of each sentence with its previous and subsequent sentences.

In this regard, the range of sentences of which context needs to be considered varies according to the presence/absence of noise included in the target document data. Specifically, the range of sentences of which context needs to be considered varies according to the presence/absence of noise or the like caused from, for example, a method of writing the target document data or personal characteristics such as a speaking way when the contents written in the target document data are spoken. Further, the range of sentences of which context needs to be considered varies according to the presence/absence of noise or the like caused from, for example, a difference in domain (contents) between the target document data and the training document data.

Thus, when distributing the respective sentences included in the target document data to multiple clusters, the change detecting device 1 needs to make a determination while changing the range of sentences of which context needs to be considered.

Specifically, in this case, as illustrated in FIGS. 4A to 4I the change detecting device 1 generates the plane described in FIG. 2 and the time-series data described in FIGS. 3A and 3B multiple times, while changing the number of sentences for which a moving average is performed (the range of sentences of which context needs to be considered). Then, the change detecting device 1 distributes the respective sentences included in the target document data to clusters, by using time-series data which may be determined to exhibit a rough change, among the time-series data generated multiple times.

More specifically, for example, as illustrated in FIGS. 4A to 4C, the change detecting device 1 generates the plane and the time-series data for a case where the number of sentences for which the moving average is performed is two. Further, for example, as illustrated in FIGS. 4D to 4F, the change detecting device 1 generates the plane and the time-series data for a case where the number of sentences for which the moving average is performed is four.

Further, for example, as illustrated in FIGS. 4G to 4I the change detecting device 1 generates the plane and the time-series data for a case where the number of sentences for which the moving average is performed is six.

Then, in the examples illustrated in FIGS. 4A to 4I the value on the X axis increases as the number of sentences for which the moving average is performed increases, for the time-series data (FIGS. 4B, 4E, and 4H) that each correspond to the first vector value (the vector value that corresponds to the value on the X axis) of the two-dimensional vector values that correspond to each sentence. Further, in the examples illustrated in FIGS. 4A to 4I the value on the Y axis decreases as the number of sentences for which the moving average is performed increases, for the time-series data (FIGS. 4C, 4F, and 4I that each correspond to the second vector value (the vector value that corresponds to the value on the Y axis) of the two-dimensional vector values that correspond to each sentence. That is, the examples illustrated in FIGS. 4A to 4I represent that it is possible to acquire the time-series data that exhibits a relatively rough change, as the number of sentences for which the moving average is performed increases.

Thus, in this case, the change detecting device 1 distributes the respective sentences included in the target document data to clusters by using, for example, the time-series data (FIGS. 4H and 4I for a case where the number of sentences for which the moving average is performed is six.

However, as described above, when the distribution to clusters is performed while changing the range of sentences of which context needs to be considered, a relatively long time may be required according to the presence/absence of noise included in the target document data. Thus, the change detecting device 1 may require a relatively long time for detecting sentences related to the same topic in the target document data.

Thus, the change detecting device 1 according to the present embodiment calculates multiple vector values that correspond to the multiple sentences included in the target document data, respectively (hereinafter, also simply referred to as vectors), based on words included in each of the multiple sentences. Then, the change detecting device 1 performs a frequency analysis based on the multiple vector values, and the time axis associated with the multiple vector values according to the writing order of the multiple sentences in the target document data. Thereafter, the change detecting device 1 outputs information indicating a position that corresponds to a change point identified based on the result of the frequency analysis, in the target document data.

That is, for example, the change detecting device 1 performs the frequency analysis on the multiple vector values that correspond to the multiple sentences included in the target document data, respectively (hereinafter, also referred to as pre-extraction vector values), so as to detect a rough change for the pre-extraction vector values. Then, based on the detected rough change, the change detecting device 1 detects a portion of the target document data that is related to the same topic.

Specifically, for example, the change detecting device 1 expresses the pre-extraction vector values as time-series data according to the writing order in the target document data, and extracts low-frequency components in the time-series data. Here, the low-frequency components refer to frequency components that correspond to a frequency equal to or lower than a predetermined threshold value, and correspond to, for example, about 10% of the frequency components that correspond to the time-series data from the lowest frequency component. Then, the change detecting device 1 identifies the multiple vector values that correspond to the extracted low-frequency components (hereinafter, also referred to as post-extraction vector values), as vector values that exhibit a rough change for the pre-extraction vector values.

Then, the change detecting device 1 distributes each of the identified post-extraction vector values to multiple clusters, based on the similarity relationship thereof. Further, the change detecting device 1 identifies, for example, a set of sentences that correspond to vector values included in different clusters, among sets of sentences of which writing positions are adjacent to each other in the target document data, and detects the position between the sentences included in the identified set of sentences as a change point of the topic.

As a result, the change detecting device 1 may identify one or more sentences related to the same topic in the target document data, without considering the relationship thereof with previous and subsequent sentences included in the target document data. Thus, the change detecting device 1 may identify one or more sentences related to the same topic in the target document data at a relatively high speed.

Meanwhile, the frequency that corresponds to the low-frequency components described above is, for example, about 0 Hz to about 0.1 Hz in a case where each sentence included in the target document data is replaced in units of seconds.

<Hardware Configuration of Information Processing System>

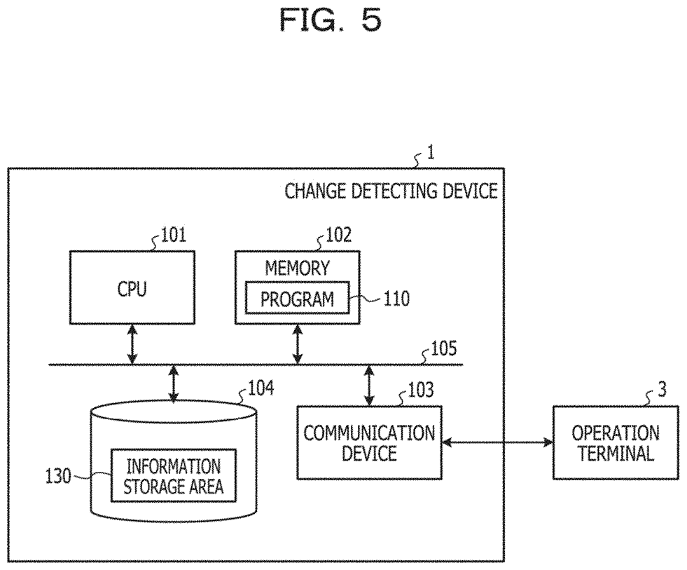

Next, a hardware configuration of the information processing system 10 will be described. FIG. 5 is a view illustrating the hardware configuration of the change detecting device 1.

As illustrated in FIG. 5, the change detecting device 1 may be implemented by a computer (information processing apparatus) that includes a CPU 101 which is a processor, a memory 102, a communication device 103, and a storage medium 104. The respective units are connected to each other via a bus 105.

The storage medium 104 has a program storage area (not illustrated) where, for example, a program 110 for performing the change detecting process is to be stored. Further, the storage medium 104 has an information storage area 130 where, for example, information used when the change detecting process is performed is to be stored. Meanwhile, the storage medium 104 may be, for example, an HDD (hard disk drive) or an SSD (solid state drive).

The CPU 101 executes the program 110 loaded from the storage medium 104 into the memory 102 to perform the change detecting process.

Further, the communication device 103 communicates with the operation terminal 3 via, for example, a network NW.

<Function of Information Processing System>

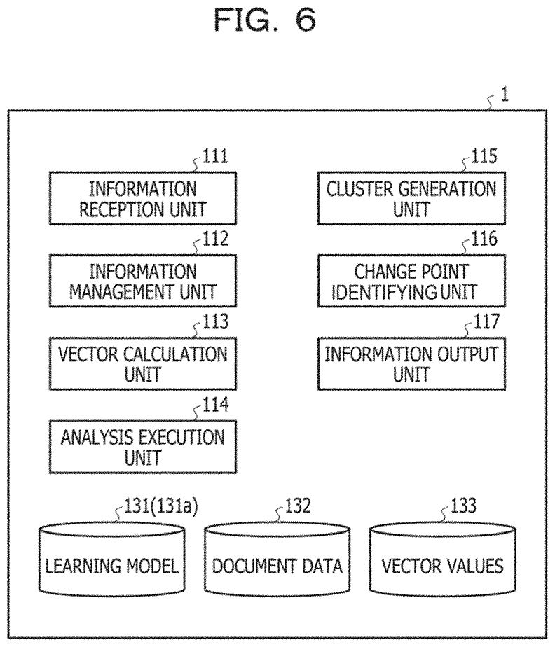

Next, the function of the information processing system 10 will be described. FIG. 6 is a functional block diagram of the change detecting device 1.

As illustrated in FIG. 6, the change detecting device 1 implements various functions which include an information reception unit 111, an information management unit 112, a vector calculation unit 113, and an analysis execution unit 114, in the manner that the hardware such as the CPU 101 or the memory 102 organically cooperates with the program 110. Further, the change detecting device 1 implements various functions which include a cluster generation unit 115, a change point identifying unit 116, and an information output unit 117, in the manner that the hardware such as the CPU 101 or the memory 102 organically cooperates with the program 110.

Further, for example, as illustrated in FIG. 6, the change detecting device 1 stores a machine learning model 131, target document data 132 (hereinafter, also simply referred to as document data 132), and vector values 133 in the information storage area 130.

The information reception unit 111 receives the machine learning model 131 input by, for example, an operator via the operation terminal 3. The machine learning model 131 is a function calculated by using statistical information 131a about the appearance frequency of each word in the training document data (not illustrated). Further, the information reception unit 111 receives the document data 132 input by, for example, an operator via the operation terminal 3.

The information management unit 112 stores, for example, the machine learning model 131 received by the information reception unit 111 in the information storage area 130. Further, the information management unit 112 stores, for example, the document data 132 received by the information reception unit 111 in the information storage area 130.

Based on words included in each of the multiple sentences included in the document data 132 received by the information reception unit 111, the vector calculation unit 113 calculates multiple vector values 133 that correspond to the multiple sentences, respectively.

Specifically, the vector calculation unit 113 inputs the document data 132 stored in the information storage area 130 to the machine learning model 131 stored in the information storage area 130, so as to calculate the vector values that correspond to the multiple sentences included in the document data 132.

The analysis execution unit 114 performs the frequency analysis based on the multiple vector values 133 calculated by the vector calculation unit 113, and the time axis associated with the multiple vector values 133 according to the writing order of the multiple sentences in the document data 132.

Specifically, the analysis execution unit 114 performs, for example, a Fourier transform on the time-axis data of the multiple vector values 133 associated with the time axis (hereinafter, also referred to as first waveform data), so as to acquire frequency components that correspond to the vector values 133. Then, the analysis execution unit 114 extracts, for example, specific frequency components from the acquired frequency components. Then, the analysis execution unit 114 performs, for example, an inverse Fourier transform on the extracted specific frequency components, so as to acquire time-series data of the multiple vector values 133 associated with the time axis (hereinafter, also referred to as second waveform data).

The cluster generation unit 115 distributes the multiple vector values 133 that correspond to the second waveform data, to multiple clusters CL by using, for example, the mutual similarity of the multiple vector values 133 that correspond to the second waveform data.

For example, for each of the multiple clusters CL to which the vector values 133 are distributed by the cluster generation unit 115, the change point identifying unit 116 identifies the writing positions of the multiple sentences that correspond to the multiple vector values 133 distributed to each cluster CL, in the document data 132. Then, the change point identifying unit 116 identifies, for example, a set of sentences that correspond to the vector values 133 included in different clusters CL, among the sets of sentences of which writing positions are adjacent to each other in the document data 132. Thereafter, the change point identifying unit 116 identifies, for example, the position between the sentences included in the identified set, as a position that corresponds to a change point (a change point of the topic).

For example, the information output unit 117 outputs information indicating the position identified by the change point identifying unit 116 to the operation terminal 3 as information indicating a position that corresponds to a change point.

<Outline of First Embodiment>

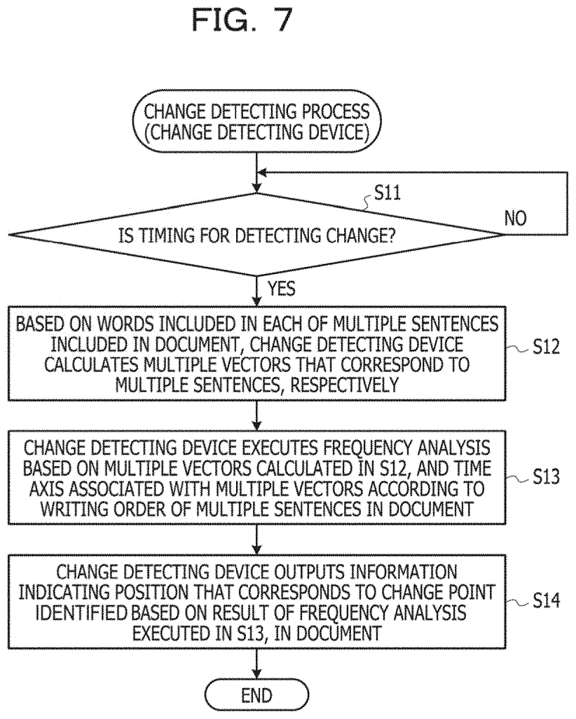

Next, the outline of the first embodiment will be described. FIG. 7 is a flowchart illustrating the outline of the change detecting process according to the first embodiment.

As illustrated in FIG. 7, the change detecting device 1 waits until a timing for detecting a change comes (NO in S11). The timing for detecting a change may be, for example, a timing at which the document data 132 input by an operator via the operation terminal 3 is received. Further, the timing for detecting a change may be, for example, a timing preset by the operator.

Then, when the timing for detecting a change comes (YES in S11), the change detecting device 1 calculates the multiple vector values 133 that correspond to the multiple sentences included in the document data 132, respectively, based on the words included in each of the multiple sentences (S12).

Subsequently, the change detecting device 1 performs the frequency analysis based on the multiple vector values 133 calculated in the process of S12, and the time axis associated with the multiple vector values 133 according to the writing order of the multiple sentences in the document data 132 (S13).

Then, the change detecting device 1 outputs information indicating the position that corresponds to a change point identified based on the result of the frequency analysis performed in the process of S13, in the document data 132 (S14).

That is, the change detecting device 1 performs, for example, the frequency analysis on the multiple vector values 133 that correspond to the multiple sentences included in the document data 132, respectively, so as to detect a rough change for the multiple vector values 133. Then, based on the detected rough change, the change detecting device 1 detects a portion of the document data 132 that is related to the same topic.

As a result, the change detecting device 1 may identify one or more sentences related to the same topic in the document data 132, without considering the relationship thereof with previous and subsequent sentences included in the document data 132. Thus, the change detecting device 1 may identify one or more sentences related to the same topic in the document data 132 at a high speed.

<Details of First Embodiment>

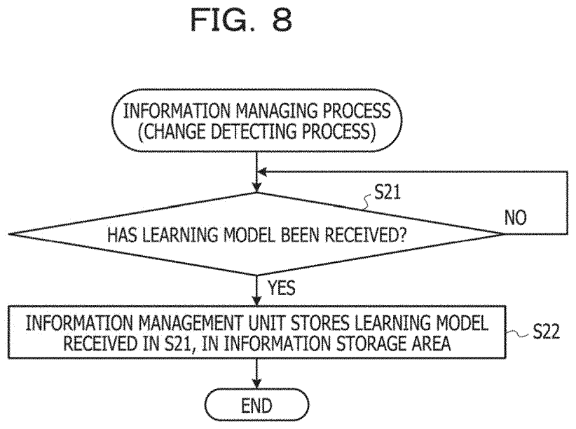

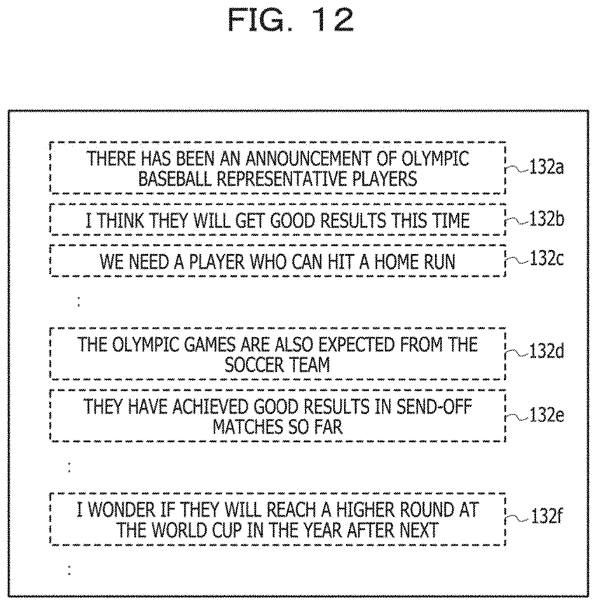

Next, the details of the first embodiment will be described. FIGS. 8 to 11 are flowcharts illustrating the details of the change detecting process according to the first embodiment. Further, FIGS. 12 to 18 are views illustrating the details of the change detecting process according to the first embodiment.

<Information Managing Process>

First, in the change detecting process, a process of managing the machine learning model 131 (hereinafter, also referred to as an information managing process) will be described. FIG. 8 is a flowchart illustrating the information managing process.

As illustrated in FIG. 8, the information reception unit 111 of the change detecting device 1 waits until the machine learning model 131 input by, for example, an operator via the operation terminal 3 is received (NO in S21).

Then, when the machine learning model 131 input by the operator via the operation terminal 3 is received (YES in S21), the information management unit 112 of the change detecting device 1 stores the received machine learning model 131 in the information storage area 130 (S22).

Meanwhile, for example, the information management unit 112 may be configured to generate the machine learning model 131 in its own device (the change detecting device 1) by a machine learning based on training document data (not illustrated). In this case, for example, the information management unit 112 may generate the machine learning model 131 by a machine learning based on the training document data which are similar in contents to the document data 132.

<Main Process of Change Detecting Process>

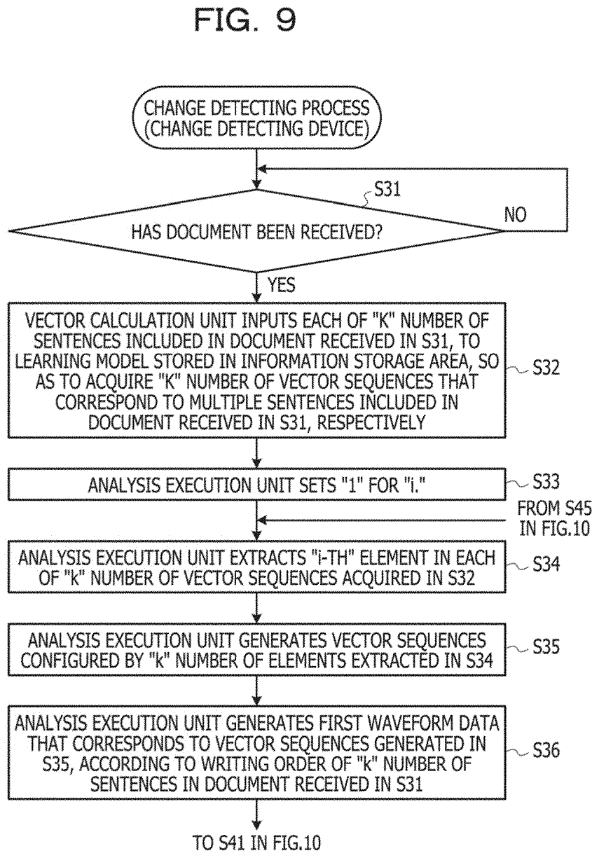

Next, the main process of the change detecting process will be described. FIGS. 9 to 11 are flowcharts illustrating the main process of the change detecting process.

As illustrated in FIG. 9, the information reception unit 111 waits until the document data 132 input by, for example, an operator via the operation terminal 3 is received (NO in S31). Hereinafter, a specific example of the document data 132 will be described.

<Specific Example of Document Data>

FIG. 12 is a view illustrating a specific example of the document data 132. Meanwhile, hereinafter, descriptions will be made assuming that the number of sentences included in the document data 132 is “k” (k is an integer of 2 or more).

The document data 132 represented in FIG. 12 includes, for example, a sentence 132a of “There has been an announcement of Olympic baseball representative players,” a sentence 132b of “I think they will get good results this time,” and a sentence 132c of “We need a player who can hit a home run.”

Further, the document data 132 represented in FIG. 12 includes, for example, a sentence 132d of “The Olympic games are also expected from the soccer team” and a sentence 132e of “They have achieved good results in send-off matches so far.”

Further, the document data 132 represented in FIG. 12 includes, for example, a sentence 132f of “I wonder if they will reach a higher round at the World Cup in the year after next.”

Referring back to FIG. 9, when the document data 132 input by the operator via the operation terminal 3 is received (YES in S31), the vector calculation unit 113 of the change detecting device 1 inputs each of the “k” number of sentences included in the document data 132 received in the process of S31, to the machine learning model 131 stored in the information storage area 130. Then, the vector calculation unit 113 acquires the values output from the machine learning model 131, as a “k” number of vector sequences 133a that correspond to the multiple sentences included in the document data 132 received in the process of S31, respectively, (sequences configured by the multiple vector values 133) (S32).

Specifically, when the input of each of the “k” number of sentences included in the document data 132 is received, the machine learning model 131 extracts nouns included in each of the “k” number of sentences. Then, the machine learning model 131 calculates the vector sequences 133a that correspond to the “k” number of sentences, respectively, by using the nouns extracted from each of the “k” number of sentences, and the statistical information 131a generated in advance as a result of the machine learning based on training document data (not illustrated). Thereafter, the machine learning model 131 outputs, for example, the “k” number of calculated vector sequences 133a. Hereinafter, a specific example of the statistical information 131a and a specific example of the process of S32 will be described.

<Specific Example of Statistical Information>

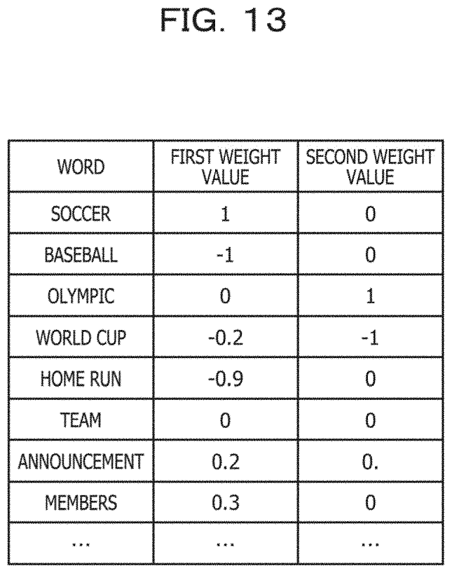

First, a specific example of the statistical information 131a will be described. FIG. 13 is a view illustrating the specific example of the statistical information 131a.

The statistical information 131a represented in FIG. 13 includes an item “Word” in which each word is set, and an item “First Weight Value” in which a first weight value used for calculating the first vector value 133 that corresponds to each word is set. Further, the statistical information 131a represented in FIG. 13 includes an item “Second Weight Value” in which a second weight value used for calculating the second vector value 133 that corresponds to each word is set. The first weight value is, for example, a value that indicates a similarity of each word to each of the words “Soccer” and “Baseball.” The second weight value is, for example, a value that indicates a similarity of each word to each of the words “Olympic games” and “World Cup.”

Specifically, for the information recorded in the first line of the statistical information 131a represented in FIG. 13, “Soccer” is set in the item “Word,” “−1” is set in the item “First Weight Value,” and “0” is set in the item “Second Weight Value.”

Further, for the information recorded in the second line of the statistical information 131a represented in FIG. 13, “Baseball” is set in the item “Word,” “−1” is set in the item “First Weight Value,” and “0” is set in the item “Second Weight Value.” Descriptions of the other information included in FIG. 13 are omitted.

<Specific Example of Process of S32>

Next, a specific example of the process of S32 will be described.

For example, when the input of the document data 132 described with reference to FIG. 12 is received, the machine learning model 131 extracts, for example, the nouns “baseball,” “Olympic,” “representative,” “players,” and “announcement” included in the sentence 132a.

Then, the machine learning model 131 calculates the average value of the first weight values that correspond to, for example, the extracted words “baseball,” “Olympic,” “representative,” “players,” and “announcement,” respectively, as the first vector value 133 that corresponds to the sentence 132a. Further, the machine learning model 131 calculates the average value of the second weight values that correspond to, for example, the extracted words “Baseball,” “Olympic,” “Representative,” “Players,” and “Announcement,” respectively, as the second vector value 133 that corresponds to the sentence 132a.

Specifically, in the statistical information 131a described with reference to FIG. 13, “1,” “−1,” “0,” “0.2,” and “0.3” are set as “first weight values” for the information of “Word” in which “Soccer,” “Baseball,” “Olympic,” “Announcement,” and “Players” are set, respectively. Further, in the statistical information 131a described with reference to FIG. 13, “0,” “0,” “1,” “0,” and “0” are set as “second weight values” for the information of “Word” in which “Soccer,” “Baseball,” “Olympic,” “Announcement,” and “Players” are set, respectively.

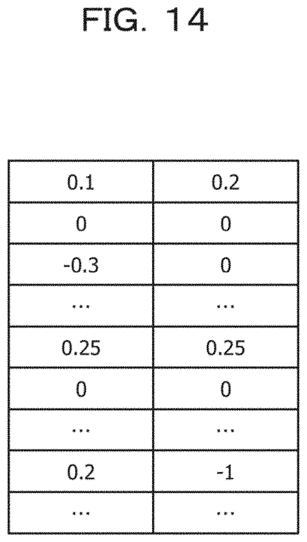

Thus, for example, as represented in the first line of FIG. 14, the machine learning model 131 extracts “0.1” which is the average value of the first weight values of the respective words extracted from the sentence 132a, as the first vector value 133 that corresponds to the sentence 132a. Further, the machine learning model 131 calculates “0.2” which is the average value of the second weight values of the respective words extracted from the sentence 132a, as the second vector value 133 that corresponds to the sentence 132a.

Further, the machine learning model 131 calculates the vector values 133 that correspond to the other sentences including, for example, the sentences 132b, 132c, 132d, 132e, and 132f, respectively.

Specifically, for example, as represented in the second line of FIG. 14, the machine learning model 131 calculates “0” which is the average value of the first weight values of the respective words extracted from the sentence 132b, as the first vector value 133 that corresponds to the sentence 132b. Further, for example, as represented in the second line of FIG. 14, the machine learning model 131 calculates “0” which is the average value of the second weight values of the respective words extracted from the sentence 132b, as the second vector value that corresponds to the sentence 132b. Descriptions of the other information in FIG. 14 are omitted.

Thereafter, the machine learning model 131 outputs the “k” number of vector sequences 133a that correspond to the “k” number of sentences including the sentence 132a and others.

Referring back to FIG. 9, the analysis execution unit 114 of the change detecting device 1 sets 1 for “i” which is a variable used as a counter (S33).

Then, the analysis execution unit 114 extracts an i-th element in each of the “k” number of vector sequences 133a acquired in the process of S32 (S34).

Specifically, the analysis execution unit 114 extracts, for example, the first vector values 133 (the “k” number of vector values 133) included in the “k” number of vector sequences 133a described with reference to FIG. 14, respectively.

Subsequently, the analysis execution unit 114 generates the vector sequences 133b configured by the “k” number of elements extracted in the process of S34 (S35).

Thereafter, the analysis execution unit 114 generates first waveform data WD1 that corresponds to the vector sequences 133a generated in the process of S35, according to the writing order of the “k” number of sentences in the document data 132 received in the process of S31 (S36).

That is, the analysis execution unit 114 generates time-series data of the vector values 133 in a case where each sentence in the document data 132 is written in a time-series order.

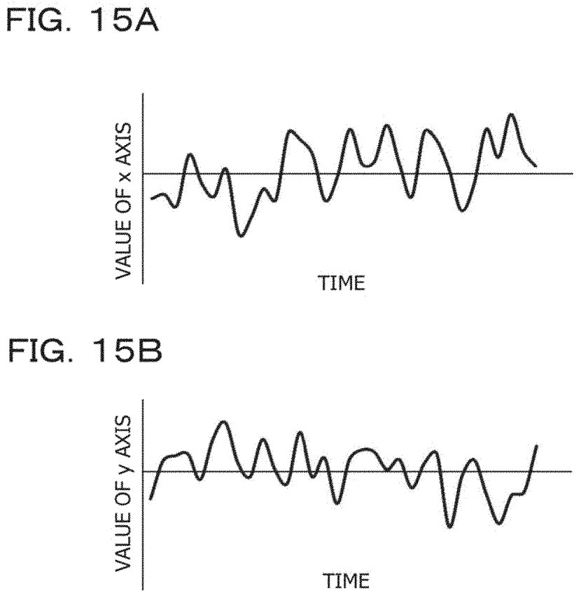

Specifically, for example, as illustrated in FIGS. 15A and 15B, the analysis execution unit 114 generates the first waveform data WD1 (FIG. 15A) that corresponds to the first vector values 133 which make up the vector sequences 133a generated in the process of S35, and the first waveform data WD1 (FIG. 15B) that corresponds to the second vector values 133.

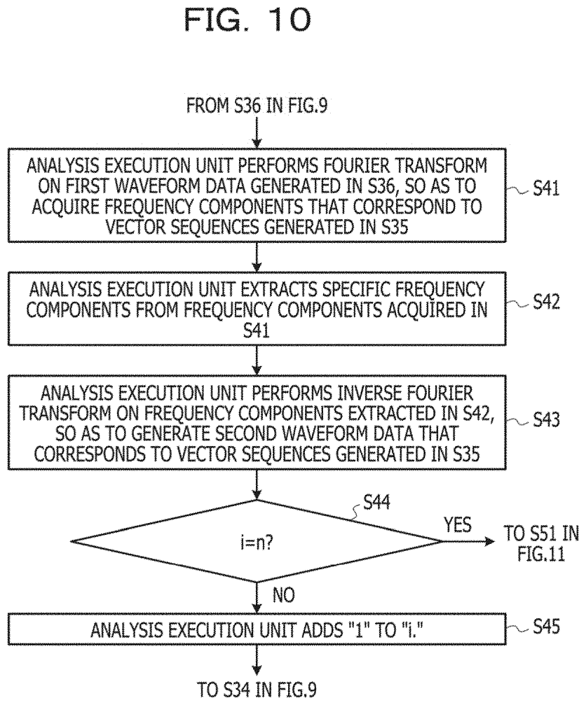

Then, as illustrated in FIG. 10, the analysis execution unit 114 performs the Fourier transform (fast Fourier transform) on the first waveform data WD1 generated in the process of S36, so as to acquire frequency components FC that correspond to the vector sequences 133a generated in the process of S35 (S41).

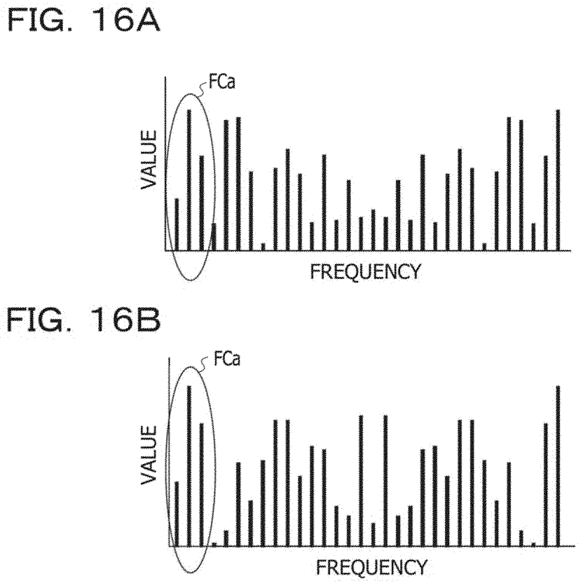

Specifically, as illustrated in FIGS. 16A and 16B, the analysis execution unit 114 generates a graph (FIG. 16A) that represents the frequency components FC acquired from the first waveform data WD1 described with respect to FIG. 15A, and a graph (FIG. 16B) that represents the frequency components FC acquired from the first waveform data WD1 described with respect to FIG. 15B.

Subsequently, the analysis execution unit 114 extracts specific frequency components FC from the frequency components FC acquired in the process of S41 (S42).

Specifically, for example, as illustrated in FIGS. 16A and 16B, the analysis execution unit 114 extracts low-frequency components FCa from the frequency components FC.

Further, the analysis execution unit 114 performs the inverse Fourier transform on the frequency components extracted in the process of S42, so as to generate second waveform data WD2 that corresponds to the vector sequences 133a generated in the process of S35 (S43).

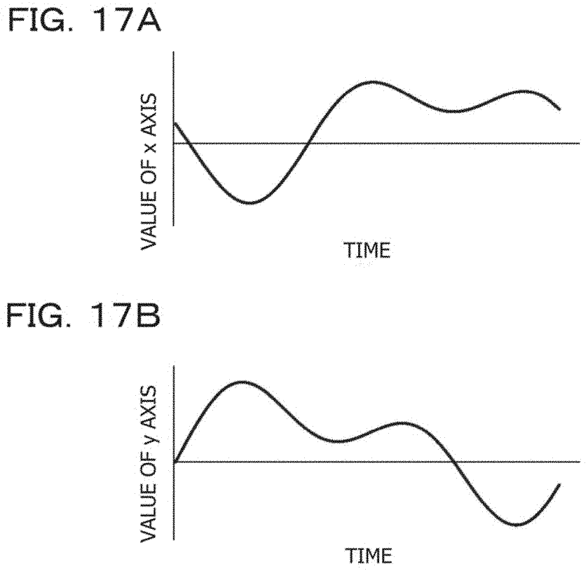

Specifically, as illustrated in FIGS. 17A and 17B, the analysis execution unit 114 generates second waveform data WD2 (FIG. 17A) that expresses a rougher change than that in the first waveform data WD1 represented in FIG. 15A, and second waveform data WD2 (FIG. 17B) that expresses a rougher change than that in the first waveform data WD1 represented in FIG. 15B.

That is, the first waveform data WD1 generated by the process of S36 may include rough noise caused from a sentence of which topic cannot be identified (a sentence unrelated to a topic to be identified), a writing habit of a writer of the document data 132 or the like.

Further, for example, when the document data 132 received in the process of S31 is document data such as minutes of a meeting or the like, it may be determined that sentences corresponding to the same topic are collectively located in the document data 132.

Thus, for example, the analysis execution unit 114 may extract only the low-frequency components that correspond to the first waveform data WD1, and generate the second waveform data WD2 that corresponds to the extracted low-frequency components, so that it is possible to acquire waveform data that excludes the rough noise and expresses a rough change of the topic.

As a result, the change detecting device 1 may identify one or more sentences related to the same topic in the document data 132, without considering the relationship thereof with other sentences included in the document data 132. Thus, the change detecting device 1 may identify one or more sentences related to the same topic in the document data 132 at a high speed.

Thereafter, the analysis execution unit 114 determines whether “i” has reached “n” which is the number of vector values 133 included in the vector sequences 133a, respectively, acquired in the process of S32 (S44).

As a result, when it is determined that “i” has not reached “n” (NO in S44), the analysis execution unit 114 adds 1 to “i” (S45), and then, performs the process of S34 and subsequent processes.

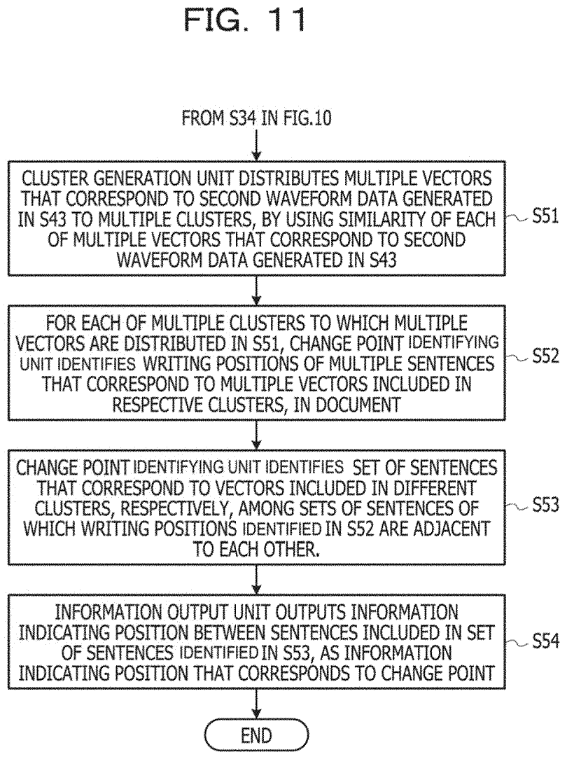

Meanwhile, when it is determined that “i” has reached “n” (YES in S44), the cluster generation unit 115 of the change detecting device 1 distributes the multiple vector values 133 that correspond to the second waveform data WD2 generated in the process of S43 to the multiple clusters CL, by using the similarity of each of the multiple vector values 133 that correspond to the second waveform data WD2 generated in the process of S43, as illustrated in FIG. 11 (S51).

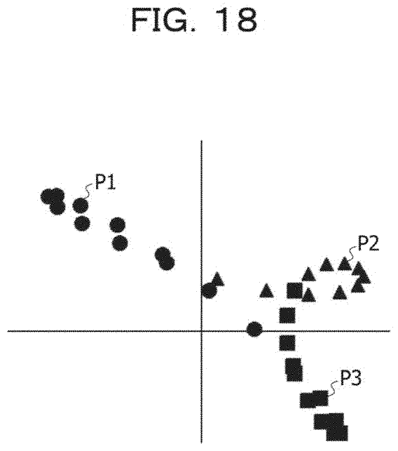

Specifically, for example, as illustrated in FIG. 18, the cluster generation unit 115 plots a point where each of the multiple vector values 133 that correspond to the second waveform data WD2 is associated with a value on the horizontal axis (X axis) and a value on the vertical axis (Y axis), on a two-dimensional plane. Then, the cluster generation unit 115 distributes each of the multiple vector values 133 that correspond to the second waveform data WD2 to the multiple clusters CL, in the manner that vectors close to each other in distance on the two-dimensional plane are distributed to the same cluster CL.

Then, for each of the multiple clusters CL to which sentences are distributed in the process of S51, the change point identifying unit 116 of the change detecting device 1 identifies the writing positions of the multiple sentences that correspond to the multiple vector values 133 included in each cluster CL, in the document data 132 (S52).

Subsequently, the change point identifying unit 116 identifies a set of sentences that correspond to the vector values 133 included in different clusters CL, respectively, among the sets of sentences of which writing positions identified in the process of S52 are adjacent to each other (S53).

Thereafter, the information output unit 117 of the change detecting device 1 outputs information indicating the position between the sentences included in the set identified in the process of S53, as information indicating a position that corresponds to a change point of the topic in the document data 132 (S54).

Meanwhile, the analysis execution unit 114 may, for example, extract high-frequency components of the frequency components FC in the process of S42. In this case, the analysis execution unit 114 may detect a change point where the topic changes significantly, in the document data 132.

As described above, the change detecting device 1 of the present embodiment calculates the multiple vector values 133 that correspond to the multiple sentences included in the document data 132, respectively, based on the words included in each of the multiple sentences. Then, the change detecting device 1 executes the frequency analysis based on the multiple vector values 133 and the time axis associated with the multiple vector values 133 according to the writing order of the multiple sentences in the document data 132. Thereafter, the change detecting device 1 outputs information indicating a position that corresponds to the change point identified based on the result of the frequency analysis, in the document data 132.

That is, the change detecting device 1 performs the frequency analysis on the multiple vector values (pre-extraction vector values) that correspond to the multiple sentences included in the document data 132, respectively, so as to detect a rough change for the pre-extraction vector values. Then, based on the detected rough change, the change detecting device 1 detects a portion of the document data 132 that is related to the same topic.

Specifically, the change detecting device 1 expresses, for example, the pre-extraction vector values as time-series data according to the writing order in the document data 132, and extracts low-frequency components in the time-series data. Then, the change detecting device 1 identifies the multiple vector values (post-extraction vector values) that correspond to the extracted low-frequency components, as vector values that indicate a rough change for the pre-extraction vector values.

Thereafter, the change detecting device 1 distributes each of the identified post-extraction vector values to the multiple clusters based on the similarity relationship thereof. Further, the change detecting device 1 identifies, for example, a set of sentences that correspond to vector values included in different clusters, respectively, among the sets of sentences of which writing positions are adjacent to each other in the document data 132, and detects the position between the sentences included in the identified set of sentences, as a change point of the topic.

As a result, the change detecting device 1 may identify one or more sentences related to the same topic in the document data 132, without considering the relationship thereof with previous and subsequent sentences included in the document data 132. Thus, the change detecting device 1 may identify one or more sentences related to the same topic in the document data 132 at a high speed. Specifically, for example, the change detecting device 1 may identify one or more sentences related to the same topic in the document data 132 in a quasi-linear time of the number of sentences included in the document data 132.

According to an aspect of the embodiment, a topic may be identified in units of a sentence.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
calculating, based on words included in each of a plurality of sentences included in a target document, a plurality of vectors that respectively correspond to the plurality of sentences;
executing a frequency analysis based on the plurality of vectors and a time axis associated with the plurality of vectors according to a writing order of the plurality of sentences in the target document; and
outputting information that indicates a position that corresponds to a change point identified based on a result of the frequency analysis, in the target document.

2. The non-transitory computer-readable recording medium according to claim 1, the process further comprising:
inputting each of the plurality of sentences included in the target document, to a machine learning model that is obtained by a machine learning based on an appearance frequency of a word in each of a plurality of sentences included in another document, so as to calculate the plurality of vectors that correspond to the plurality of sentences included in the target document, respectively.

3. The non-transitory computer-readable recording medium according to claim 1, the process further comprising:
performing a Fourier transform on first waveform data of the plurality of vectors associated with the time axis, so as to acquire frequency components that correspond to the plurality of vectors;
extracting specific frequency components from the acquired frequency components;
performing an inverse Fourier transform on the extracted specific frequency components, so as to acquire second waveform data of a plurality of other vectors associated with the time axis; and
identifying a change point based on the acquired second waveform data.

4. The non-transitory computer-readable recording medium according to claim 3, wherein
the specific frequency components are frequency components that correspond to a frequency equal to or lower than a threshold value, among the acquired frequency components.

5. The non-transitory computer-readable recording medium according to claim 3, the process further comprising:
distributing the plurality of other vectors to a plurality of clusters;
identifying a writing position of a sentence that corresponds to a vector included in each of the plurality of clusters, in the target document;
selecting a set of specific sentences of which corresponding vectors are included in different clusters, among sets of sentences of which writing positions are adjacent to each other; and
determining a position that corresponds to the selected set of specific sentences, to be the change point.

6. An information processing apparatus, comprising:
a memory; and
a processor coupled to the memory and the processor configured to:
calculate, based on words included in each of a plurality of sentences included in a target document, a plurality of vectors that respectively correspond to the plurality of sentences;
execute a frequency analysis based on the plurality of vectors and a time axis associated with the plurality of vectors according to a writing order of the plurality of sentences in the target document; and
output information that indicates a position that corresponds to a change point identified based on a result of the frequency analysis, in the target document.

7. The information processing apparatus according to claim 6, wherein
the processor is further configured to:
perform a Fourier transform on first waveform data of the plurality of vectors associated with the time axis, so as to acquire frequency components that correspond to the plurality of vectors;
extract specific frequency components from the acquired frequency components;
perform an inverse Fourier transform on the extracted specific frequency components, so as to acquire second waveform data of a plurality of other vectors associated with the time axis; and
identify a change point based on the acquired second waveform data.

8. A method of detecting a change, the method comprising:
calculating by a computer, based on words included in each of a plurality of sentences included in a target document, a plurality of vectors that respectively correspond to the plurality of sentences;
executing a frequency analysis based on the plurality of vectors and a time axis associated with the plurality of vectors according to a writing order of the plurality of sentences in the target document; and
outputting information that indicates a position that corresponds to a change point identified based on a result of the frequency analysis, in the target document.

9. The method according to claim 8, the process further comprising:
performing a Fourier transform on first waveform data of the plurality of vectors associated with the time axis, so as to acquire frequency components that correspond to the plurality of vectors;
extracting specific frequency components from the acquired frequency components;
performing an inverse Fourier transform on the extracted specific frequency components, so as to acquire second waveform data of a plurality of other vectors associated with the time axis; and
identifying a change point based on the acquired second waveform data.
